(19) United States
(12) Patent Application Publication
(10) Pub. No.: US 2013/0047492 A1
(43) Pub. Date: Feb. 28, 2013

(54) VARIABLE TENSION FISH HOOK

(71) Applicant: Kelly Frederick, Walker, LA (US)

(72) Inventor: Kelly Frederick, Walker, LA (US)

(73) Assignee: FREDERICK TECHNOLOGY FIRM, I

(21) Appl. No.: 13/219,774

(22) Filed: Aug. 29, 2011

(51) Int. Cl. A01K 83/02; A01K 83/00

(52) U.S. Cl. 43/43.2; 43/44.6

(57) ABSTRACT

The present invention is an apparatus for fishing is provided in the form of a hook is herein disclosed with multiple hook points, an adjustable tension arm, optional snag guard and auxiliary bait retainer.

### BACKGROUND OF THE INVENTION

The present invention relates to an improved design of a multi-featured fishing hook.

Fishing hooks are available in a multitude of designs, varying hook styles, including single and multiple hooks, shapes, colors and sizes. Traditionally, these hooks all have in common the basic elements of an eyelet for connecting to a fishing line, a shank extending therefrom, and one or more hooks formed at the end, used to secure bait and capture aquatic prey. With this basic design, a fish striking (or attempting to ingest the bait attached to the hook) will become ensnared by the hook, provided the fisherman is able to set the hook sufficiently once in the fish's mouth. This “setting” of the hook is accomplished by the fisherman detecting the strike by observing the line moving as a result of the fish's contact with the bait and line in an attempt to consume the bait, or the fisherman may feel the actual tugging on the line through the fishing rod. Once this striking activity is ascertained, the fisherman typically will tug (or “pop”) the line in order to get the hook lodged in the fish's mouth, and subsequently ensnare the fish. Once hooked in this manner, it is typically far more difficult for a fish to work its way loose of the fisherman's line.

While the above-described method may provide a user with a way to catch fish, this type of apparatus leaves open the possibility of failure due to several reasons, such as not setting the hook quickly enough and having the target fish consume the bait without the hook, having a fish spit the hook out before it has a chance to be set, tugging too violently on the line and pulling the hook from the fish's mouth before it has a chance to be set, and/or tugging too softly and not having the hook set within the fish's mouth. If any of these circumstances, or myriad others, occurs, the fish will not be sufficiently secured to the line, and will typically escape capture.

Clear downsides to the current mode of fishing with a traditional hook exist. Firstly, an easy to set solution is not readily available, as the fisherman must keep steady vigil over his line in order to detect any striking activity. Secondly, even while the common method of using a fishing hook may have design variations which help to promote setting of the hook, none offer a solution which automatically helps set the hook once struck by the aquatic prey. Further, additional features which provide for additional bait securing and/or snag protection have not been available with fishing hooks. For those methods employed by others to supply an improved hook design which are now available, the concept is often overwrought and/or ineffective in its implementation.

The consequence of these issues is the inherent ineffectiveness of the current state of the art for fishing hooks. The absence of a solution which provides an automatic assist with setting a hook in multiple locations in a secure manner, especially one that includes a snag guard and/or a bait securing barb, has yet to be developed. The present invention provides a simple, innovative and effective apparatus for fishing. The present invention of a revised fishing hook is thus a novel, needed and functional answer to the problems in the field relating to having an effective fishing hook.

All of these aspects of the current state of fishing hooks lead to an increased need for a revised method of implementation with minimized cost and complexity, all of which the present invention addresses.

### OBJECTS OF THE INVENTION

One object of the invention is to provide a new fishing hook design.

An additional object of this invention is to provide a fishing apparatus with an adjustable tension arm for setting a hook in a fish when fishing.

Another object of this invention is to provide a new apparatus for hooking a fish in multiple places.

Yet another object of this invention is to provide a fishing hook with a snag guard to prevent a fishing hook from getting caught in vegetation and other hazards.

Still another object of this invention is to provide a fishing hook with a barb that aids in securing bait to a fishing hook.

Other objects and advantages of this invention shall become apparent from the ensuing descriptions of the invention.

### SUMMARY OF THE INVENTION

According to the present invention, an apparatus for fishing is provided in the form of a hook is herein disclosed with multiple hook points, an adjustable tension arm, optional snag guard and auxiliary bait retainer.

### BRIEF DESCRIPTION OF THE DRAWINGS

The accompanying drawings and figures illustrate embodiment(s) of this invention. However, it is to be understood that these embodiments are intended to be neither exhaustive, nor limiting of the invention. They are but examples of some of the forms in which the invention may be practiced.

FIG. 1 is a perspective view of the fishing hook.

FIG. 2 is a side view of the fishing hook.

FIG. 3 is a top view of the fishing hook in the unloaded position.

FIG. 4 is a top view of the fishing hook in the loaded (under tension) position.

FIG. 5 is a side view of the fishing hook in a three-hook configuration.

FIG. 6 is a top view of the fishing hook in a three-hook configuration.

FIG. 7 is a side view of the fishing hook in a four-hook configuration.

FIG. 8 is a top view of the fishing hook in a four-hook configuration.

### DETAILED DESCRIPTION OF EXEMPLARY EMBODIMENTS

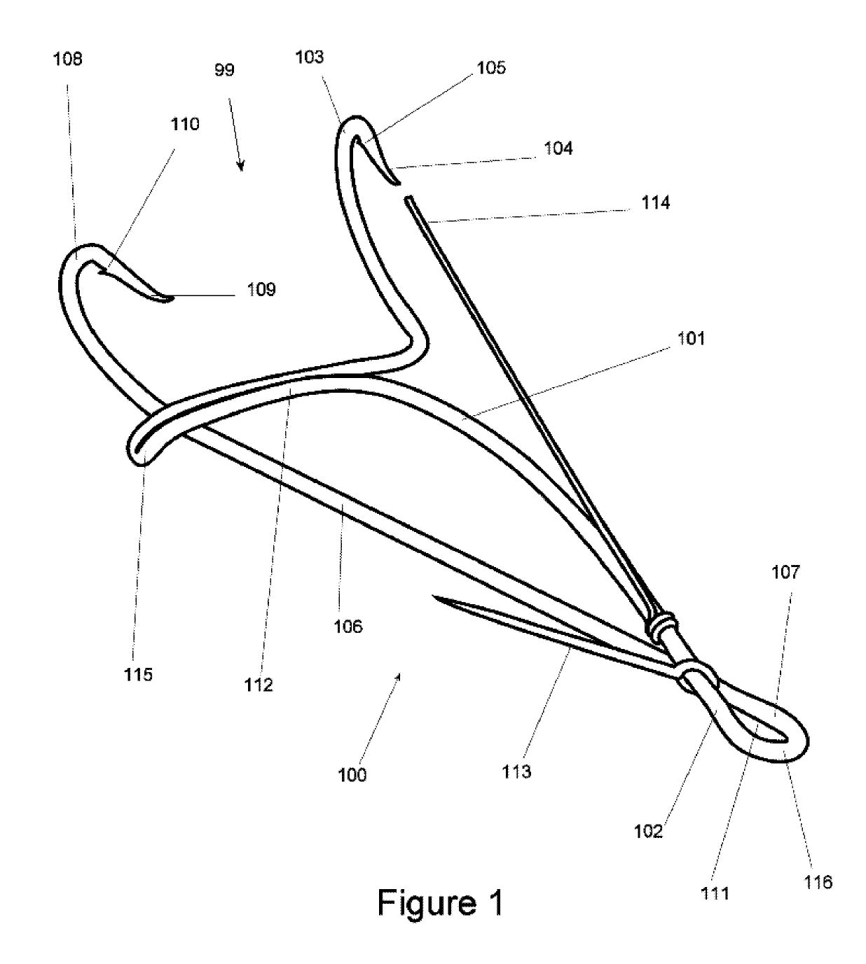

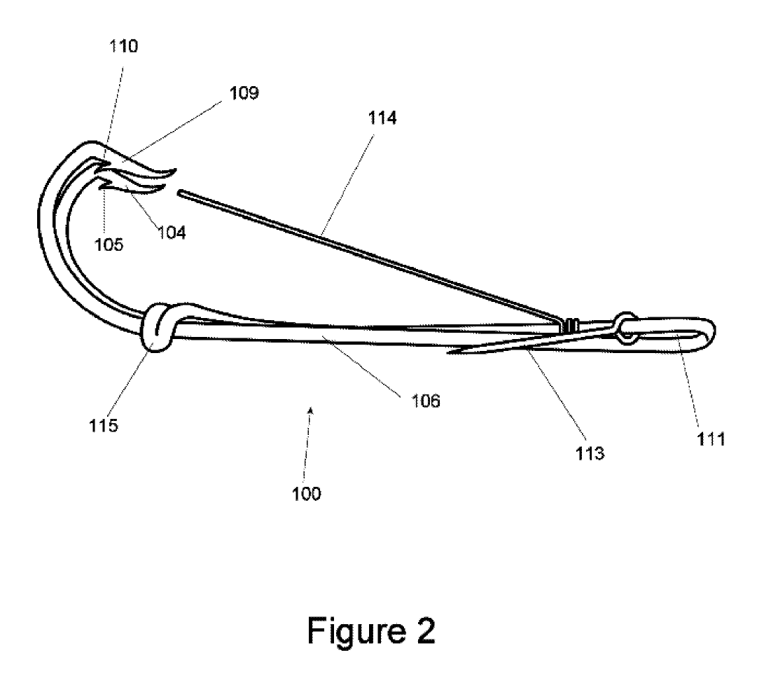

Without any intent to limit the scope of this invention, reference is made to the figures in describing the various embodiments of the invention. FIGS. 1 through 8 depict various aspects of exemplary embodiments of the present invention.

The present invention relates to fishing hook 100 as pictured in FIGS. 1 through 4. Fishing hook 100 is formed by first, or primary shank 101 which has first opposite end 102 and second opposite end 103. Second opposite end 103 is shaped to form a hook 104 and optionally, first barb 105 which can be employed to help retain a fish which may be trapped by fishing hook 100. First barb 105 is a protrusion which is formed by a relief feature along shank 101 with a point, such that the tip of the barb can easily pierce an object, but once pierced, a lack of smooth surface prevents barb 105 from being easily backed out. Similarly, fishing hook 100 includes second, or secondary shank 106, which has first opposite end 107 and second opposite end 108 which is also shaped to form a hook 109 and optionally second barb 110. The two shanks are connected at a common point 116 where first shank's 101 first opposite end 102 is joined to second shank's 106 first opposite end 107. These can be joined to form an eyelet through which fishing or other line(s) can be secured to hook 100. These shanks, 101, 106 form hook pair 99. In an exemplary embodiment, the entirety of the above hook 100 is formed of one continuous piece of material, typically a metal or other durable, malleable material, for ease of construction and for increased structural integrity.

Tension arm 112 is formed along the length of first shank 101, typically by forming a portion of first shank 101 into a shaft perpendicular to first shank 101 and which is shaped to engage second shank 106 and hold it in tension. In tension in this example means that first shank 101 and second shank 106 are pulled together in closer relation against the forces of the two shanks 101, 106 common point 116 and retained in place by tension arm interlock 115. One exemplary method of this type of arrangement is by having tension arm 112 include a small bend as interlock 115 which is shaped to retain second shank 106 in tension.

Optionally, fishing hook 100 can also employ snag guard 114. Sang guard 114 is formed of a length of material substantially perpendicular to shanks 101, 106, affixed and extending substantially from either or both first shank's 101 and second shank's 106 first opposite end 102, 107 toward hooks 104, 109, and terminating near hooks 104, 109. In this way, weeds and other debris are less likely to become tangled in hooks 104, 109 and cause snags, loss of the hook or other detrimental effects. This is accomplished because snag guard 114 discourages the entry of weeds and the like into the plane formed between hooks 104, 109 and first opposite ends 102, 107 thus preventing same from being snared by hooks 104, 109

Additionally, fishing hook 100 can include secondary barb 113 on either or both first shank's 101 and second shank's 106 first opposite end 102, 107. Secondary barb(s) 113 extend downward toward hooks 104, 109 and are used to help retain bait within fishing hook 100. Secondary barb 113 is constructed of a piece of material attached to shanks 101, 106 and drawn to a point at the end. This additional point assists in capturing and retaining bait and or aquatic prey.

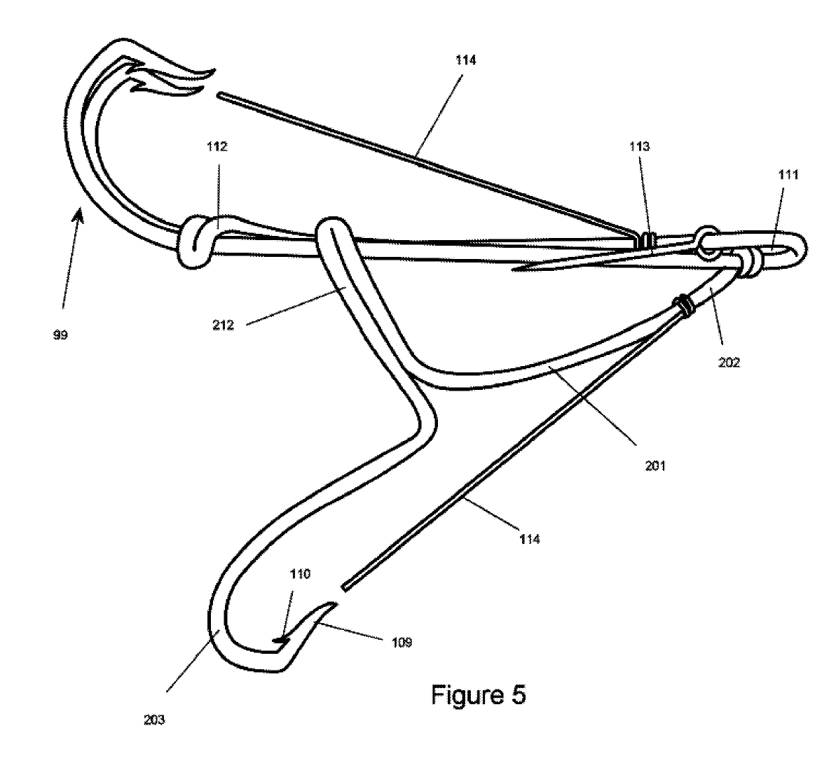

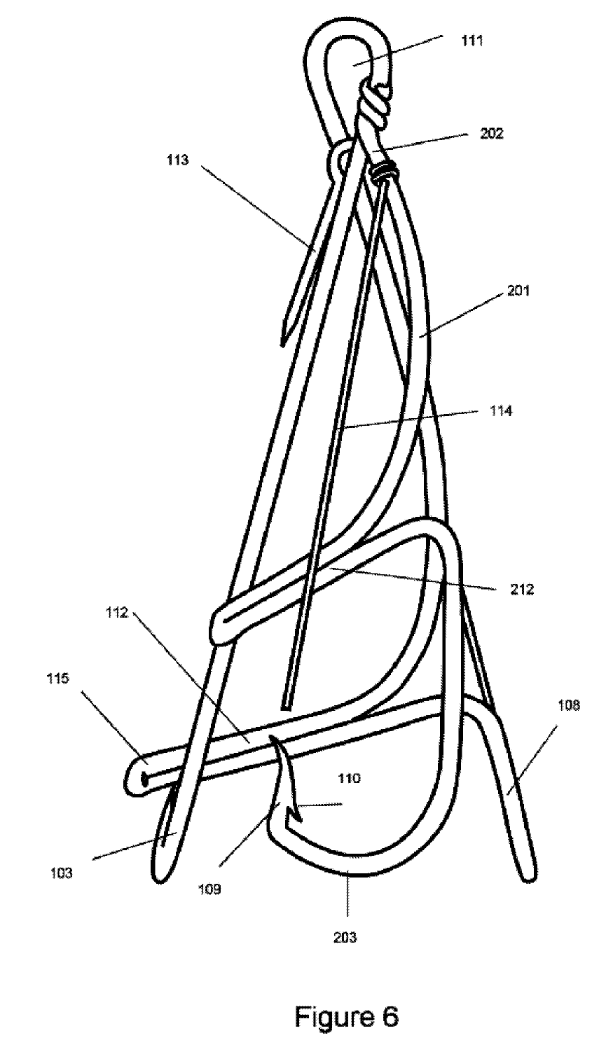

Additional exemplary embodiments are pictured in FIGS. 5-8. FIGS. 5 and 6 show a odd-numbered-hook configuration, in this case, three hooks, wherein hook pair 99 is coupled with at least a third shank 201 having first opposite end 202 and second opposite end 203. Identical in construction to above tension arm 112, tension arm 212 is formed along the length of third shank 201, typically by forming a portion of first shank 201 into a shaft perpendicular to first shank 201 and which, in this iteration, is shaped to engage either first shank 101 or second shank 106 and hold it in tension.

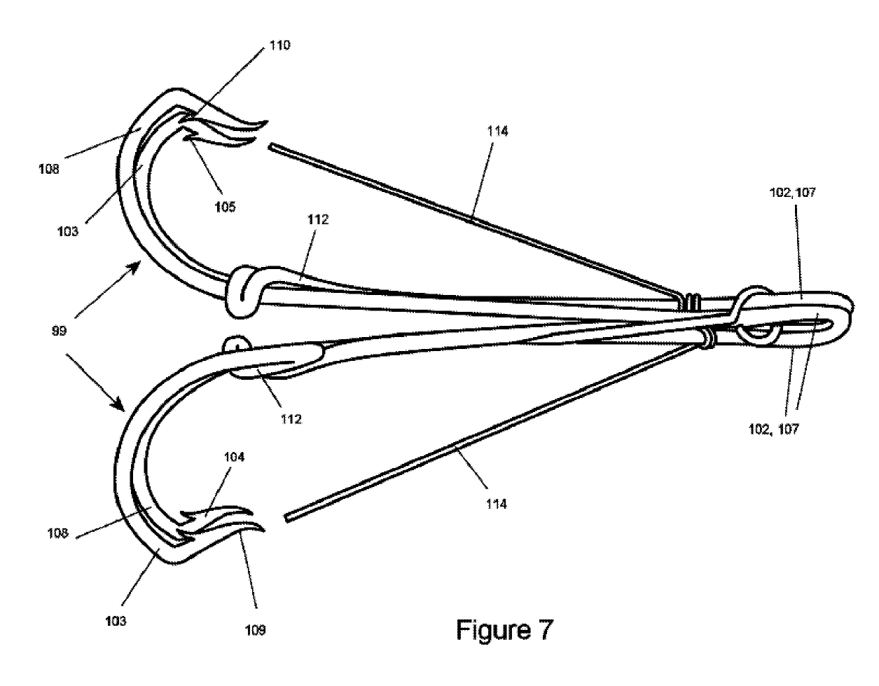

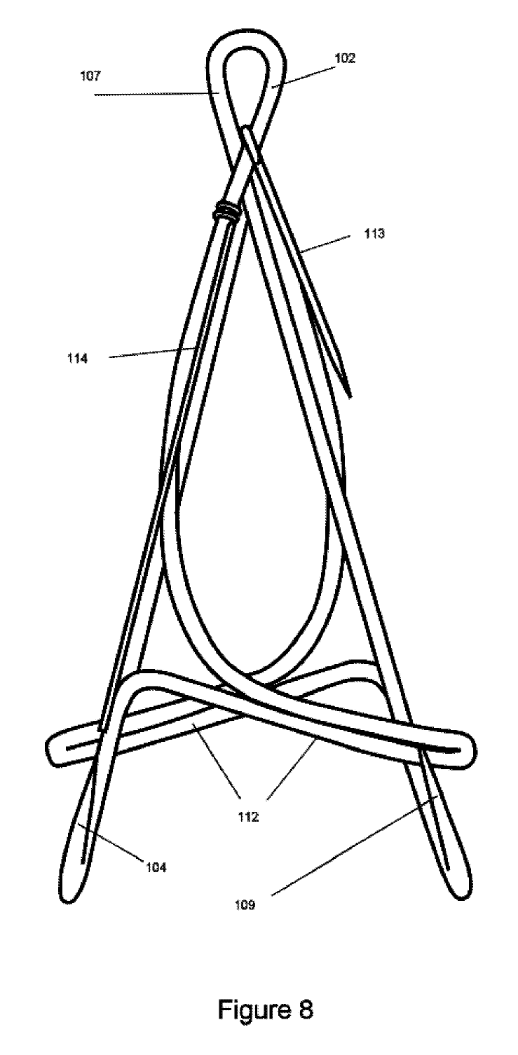

FIGS. 7 and 8 illustrated another exemplary embodiment utilizing a configuration with multiple hook pairs 99. This embodiment adjoins multiple hook pairs 99 together near first opposite ends 102,107 of hook pairs 99, such that many hook pairs 99 can be utilized for capturing aquatic prey.

In either of the alternate exemplary embodiments, hooks 104, snag guards, 114, secondary barbs 113, are all employed in the same manner on the additional hook pairs 99 or third shank 201, if desired.

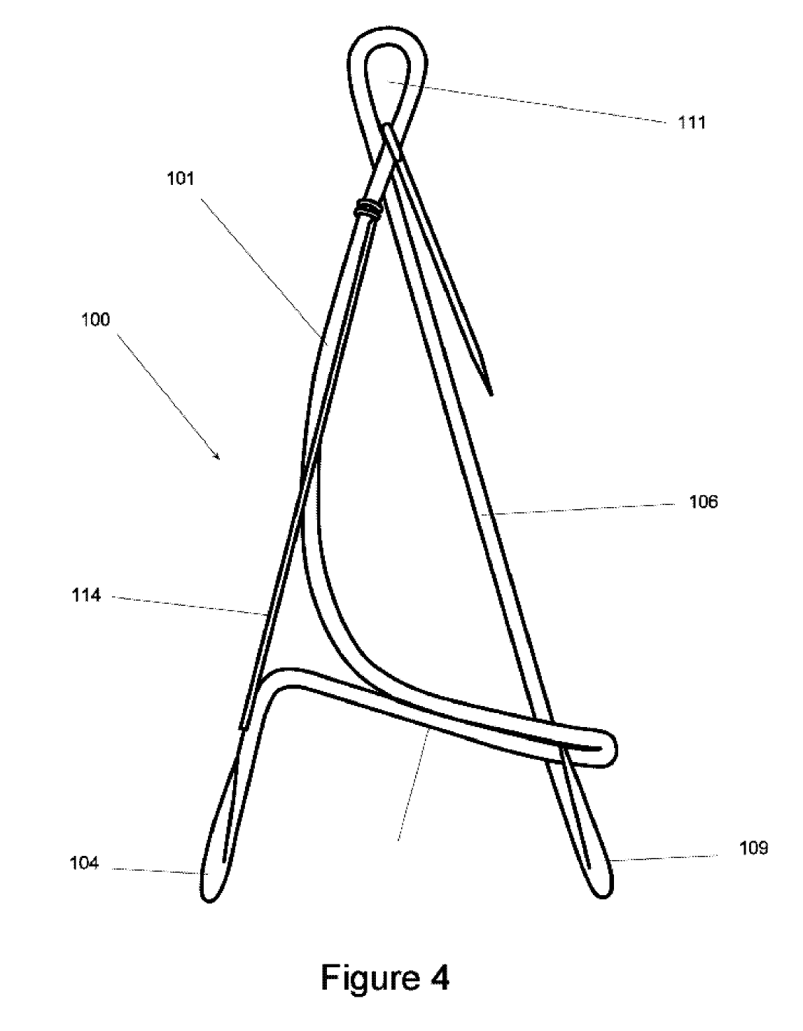

In operation, then, fishing hook 100 is attached to the operator's line of choice via eyelet 111. Tension arm 112 is then “set” by putting tension between first shank 101 and second shank 106 and then using tension arm 112 on first shank 101 to engage second shank 106 with interlock 115, as seen in FIG. 4. Fishing hook 100 can then be baited, on first hook 104 or second hook 109, depending on configuration, and cast in the desired location.

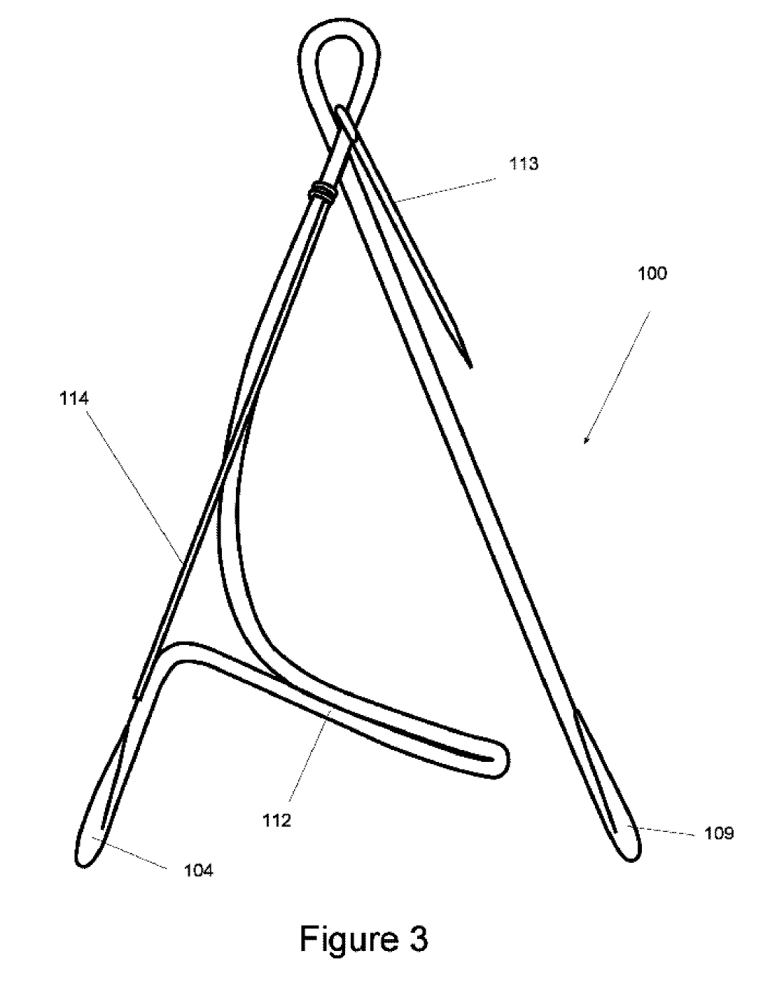

When hook 100 is “hit” or attempted to be ingested by a fish, tension arm 112 will be released by the agitation and turbulent action about hook 100, and will spring open, as seen in FIG. 3. This widens the spread of hook 100, decreasing the odds that the fish will be able to spit out hook 100. Simultaneously, the splayed hooks 104, 109 are much more likely to snare the fish. Either or both of the above actions ensure a more secured aquatic prey.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

The invention claimed is:

1. A fishing hook comprising at least one hook pair and wherein said at least one hook pair is comprised of:
a. a first shank having first and second opposite ends wherein second opposite end is shaped to form a first hook;
b. a second shank having first and second opposite ends wherein said first shank's first opposite end is operatively attached to said second shank's first opposite end and wherein said second shank's second opposite end is shaped to form a second hook; and
c. a tension arm formed by said first shank proximately to said second opposite end and extending perpendicularly to said first shank and formed to operatively engage said second shank in tension.

2. The fishing hook of claim 1 further comprising at least a second hook pair identical to said at least first hook pair, wherein said second hook pair comprises:
a. a first shank having first and second opposite ends wherein second opposite end is shaped to form a first hook;
b. a second shank having first and second opposite ends wherein said first shank's first opposite end is operatively attached to said second shank's first opposite end and wherein said second shank's second opposite end is shaped to form a second hook; and
c. a tension arm formed by said first shank proximately to said second opposite end and extending perpendicularly to said first shank and formed to operatively engage said second shank in tension;
and wherein said first hook pair and said at least second hook pair are operatively attached at said first opposite ends of said shanks.

3. The fishing hook of claim 1 wherein said first and second shanks further comprise barbs formed in said shanks proximately to said hooks.

4. The fishing hook of claim 1 further comprising an eyelet formed by said first shank and said second shank proximately to said first opposite ends of said first and said second shank.

5. The fishing hook of claim 1 wherein said fishing hook is formed of a single, continuous piece of material.

6. The fishing hook of claim 1 further comprising a snag guard comprising a length of durable material operatively attached to said first shank and extending substantially from said first opposite end of said first shank to said first hook.

7. The fishing hook of claim 1 further comprising a snag guard comprising a length of durable material operatively attached to said second shank and extending substantially from said first opposite end of said second shank to said second hook.

8. The fishing hook of claim 1 further comprising a snag guard comprising a length of durable material operatively attached to said first shank and extending substantially from said first opposite end of said first shank to said first hook and further comprising a snag guard comprising a length of durable material operatively attached to said second shank and extending substantially from said first opposite end of said second shank to said second hook.

9. The fishing hook of claim 1 further comprising a secondary barb operatively attached to said first shank and extending downward toward said first hook and operatively configured to retain bait in conjunction with said first hook.

10. The fishing hook of claim 1 further comprising a secondary barb operatively attached to said second shank and extending downward toward said second hook and operatively configured to retain bait in conjunction with said second hook.

11. The fishing hook of claim 1 further comprising a secondary barb operatively attached to said first shank and extending downward toward said first hook and operatively configured to retain bait in conjunction with said first hook and further comprising a second secondary barb operatively attached to said second shank and extending downward toward said second hook and operatively configured to retain bait in conjunction with said second hook.

12. A fishing hook comprising:
a. a first shank having first and second opposite ends wherein second opposite end is shaped to form a first hook;
b. a second shank having first and second opposite ends wherein said first shank's first opposite end is operatively attached to said second shank's first opposite end and wherein said second shank's second opposite end is shaped to form a second hook;
c. a third shank having first and second opposite ends wherein said third shank's first opposite end is operatively attached to said second shank's first opposite end and said first shank's first opposite end, and wherein said third shank's said second opposite end is shaped to form a third hook;
d. a first tension arm formed by said first shank nearer said second opposite end and extending perpendicularly to said first shank and formed to operatively engage said second shank in tension; and
e. a second tension arm formed by said third shank nearer said second opposite end and extending perpendicularly to and of said first shank or said second shank and formed to operatively engage said any of said first shank or said second shank in tension.

13. The fishing hook of claim 11 further comprising a snag guard comprising a length of durable material operatively attached to said first shank and extending substantially from said first opposite end of said first shank to said first hook.

14. The fishing hook of claim 11 further comprising a snag guard comprising a length of durable material operatively attached to said second shank and extending substantially from said first opposite end of said second shank to said second hook.

15. The fishing hook of claim 11 further comprising a snag guard comprising a length of durable material operatively attached to said third shank and extending substantially from said first opposite end of said second shank to said second hook.

16. The fishing hook of claim 11 further comprising a secondary barb operatively attached to said first shank and extending downward toward said first hook and operatively configured to retain bait in conjunction with said first hook.

17. The fishing hook of claim 11 further comprising a secondary barb operatively attached to said second shank and extending downward toward said second hook and operatively configured to retain bait in conjunction with said second hook.

18. The fishing hook of claim 11 further comprising a secondary barb operatively attached to said third shank and extending downward toward said second hook and operatively configured to retain bait in conjunction with said second hook.

19. A fishing hook comprising:
a. at least one primary shank having first and second opposite ends wherein second opposite end is shaped to form a first hook;
b. at least one secondary shank having first and second opposite ends wherein said primary shank's first opposite end is operatively attached to said secondary shank's first opposite end and wherein said secondary shank's second opposite end is shaped to form a second hook; and
c. at least one tension arm formed by said at least one primary shank nearer said second opposite end of said at least one primary shank and extending perpendicularly to any other said at least one primary shank or said at least one secondary shank and formed to operatively engage said second shank in tension.
